(19) United States
(12) Patent Application Publication
(10) Pub. No.: US 2024/0223515 A1
(43) Pub. Date: Jul. 4, 2024

(54) MANAGING PROCESSING QUEUE ALLOCATION USING SEQUENCE NUMBER BITS OF AN IPSEC PACKET

(71) Applicant: VMware, LLC, Palo Alto, CA (US)

(72) Inventors: BHARGAV PUVVADA, Pune (IN); Awan Kumar Sharma, Pune (IN)

(21) Appl. No.: 18/108,683

(22) Filed: Feb. 13, 2023

(30) Foreign Application Priority Data
Dec. 30, 2022 (IN) 202241077257

(51) Int. Cl. H04L 49/90; H04L 47/34

(52) U.S. Cl. CPC H04L 49/90; H04L 47/34

(57) ABSTRACT

Described herein are systems, methods, and software manage the allocation of packets to processing queues at a gateway. In one example, a first gateway receives a packet from a second gateway, wherein the packet comprises an internet protocol security (IPsec) packet. The first gateway identifies a value in a subset of bits in a sequence number portion of the packet and selects a queue from a plurality of queues at the first gateway based on the value.

### RELATED APPLICATIONS

Benefit is claimed under 35 U.S.C. 119(a)-(d) to Foreign Application Serial No. 202241077257 filed in India entitled “MANAGING PROCESSING QUEUE ALLOCATION USING SEQUENCE NUMBER BITS OF AN IPSEC PACKET”, on Dec. 30, 2022, by VMware, Inc., which is herein incorporated in its entirety by reference for all purposes.

### BACKGROUND

In computing networks, gateways are used to provide connectivity between different computing sites or datacenters. These gateways may be used to implement network address translation, encapsulation, encryption, firewalls, Internet Protocol Security (IPsec) tunneling, or some other operations to connect the different computing sites. The computing nodes at each of the computing sites may include physical computing systems, such as desktop computing systems, servers, and the like, and may further include virtual computing systems, such as virtual machines, containers, and the like.

In some implementations, a gateway may employ multiple queues to distribute the load for the processing system of the gateway. When a packet is received, the packet may be allocated to a queue and processed in accordance with rules and other networking configurations of the gateway. However, difficulties can arise in determining how the packets should be distributed to various queues and limiting the load associated with the individual queues.

### Overview

The technology disclosed herein manages queue allocation for encapsulated packets between gateways. In at least one example, a first gateway is configured to receive a packet from a second gateway and identify a value of a subset of bits in a sequence number portion of the packet. the method is further configured to select a queue from a plurality of queues at the first gateway based on the value of the subset of bits.

In one implementation, the second gateway is configured to hash tuple information from a second packet encapsulated in the packet to generate a hash value. The second gateway then sets subset of bits in the sequence number portion of the packet to the hash value and communicates the packet to the first gateway.

### BRIEF DESCRIPTION OF THE DRAWINGS

FIG. 1 illustrates a computing environment to manage processing queue allocation according to an implementation.

FIG. 2 illustrates an operation of a gateway to identify and add bits in a sequence number portion to indicate a processing queue for a packet according to an implementation.

FIG. 3 illustrates an operation of a gateway to assign a packet to a processing queue based on the bits in a sequence number portion according to an implementation.

FIG. 4 illustrates an operational scenario of generating an internet protocol security (IPsec) packet according to an implementation.

FIG. 5 illustrates an operational scenario of assigning a received packet to a processing queue according to an implementation.

FIG. 6 illustrates a gateway computing system to communicate IPsec packet that indicate a processing queue for the packet using the sequence number portion according to an implementation.

### DETAILED DESCRIPTION

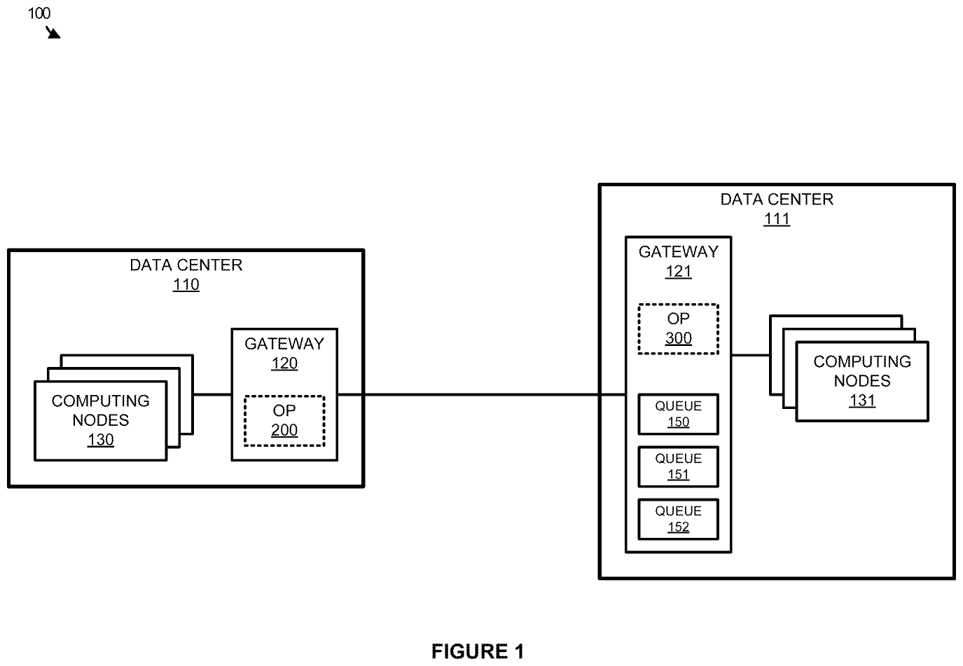

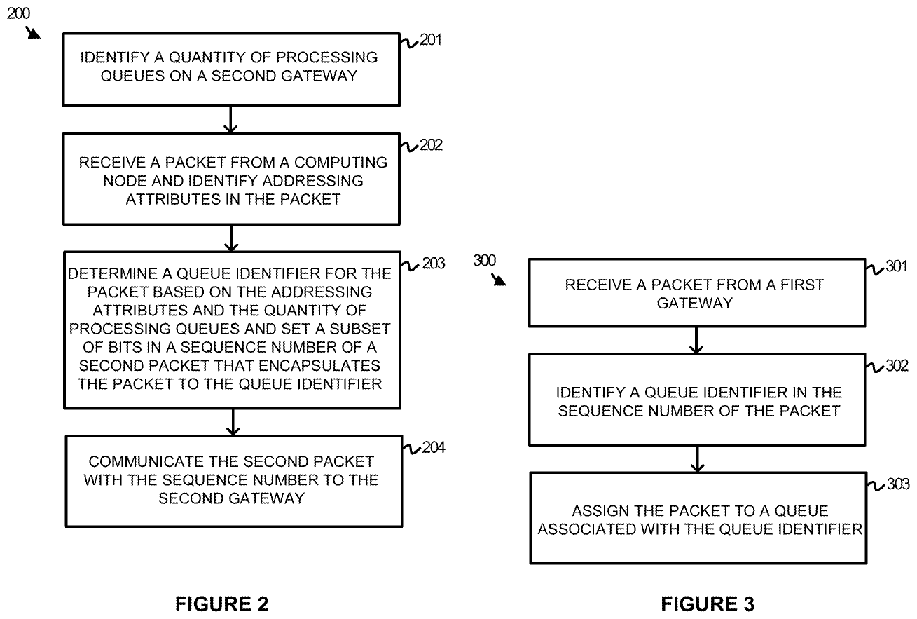

FIG. 1 illustrates a computing environment to manage processing queue allocation according to an implementation. Computing environment 100 includes data centers 110-111, wherein data centers 110-111 further include gateways 120-121 and computing nodes 130-131. Gateway 120 provides operation 200 that is further described below in FIG. 2. Gateway 121 further includes processing queues 150-152 and provides operation 300 that is further described below in FIG. 3.

In data centers 110-111, computing nodes 130-131 are deployed to provide various operations. Computing nodes 130-131 may comprise physical computing nodes, such as desktop computers, laptop computers, servers, and the like, or may comprise virtual computing nodes, such as virtual machines, containers, or some other virtual computing node. Computing nodes 110-111 may provide user desktops, front-end applications for web servers, data processing applications for web servers, database applications, or some other service.

To provide communications between computing nodes at data center 110 and data center 111, gateways 120-121 are provided. Gateways 120-121 may be used to provide firewall operations, routing operations, encapsulation operations, or some other networking operation. In one implementation, when a computing node of computing nodes 130 sends a packet destined for a computing node at data center 111, gateway 120 may receive the packet, encapsulate the packet using internet protocol security (IPsec), and forward the packet to data center 111. Once received, data center 111 may decapsulate the packet and forward the packet to the corresponding destination computing node. Advantageously, IPsec can extend a network as a virtual private network (VPN).

Here, in addition to providing the encapsulation operations for an egress packet to data center 111, gateway 120 may select a processing queue for processing the packet at gateway 121. A processing queue may correspond to a core of the CPU at the gateway, may correspond to a processor, or may correspond to some other division of processing resources on the gateway. In some examples, gateways 120-121 can exchange information about the number of available queues as part of a receive side scaling indication. For example, gateway 121 can indicate that three queues are available for packets from gateway 120, wherein the available queue information can be provided when establishing the IPsec tunnel between the gateways. In some implementations, rather than communicating the quantity of available queues between the gateways, gateways in a network can be manually configured to identify the available queues at one or more other gateways for private network communications (i.e., IPsec VPN communications).

Once the number of available queues is identified by gateway 120, gateway 120 can communicate packet to gateway 121, wherein the packet comprises an IPsec packet that encapsulates a second packet from a computing node of computing nodes 130. For example, a computing node of computing nodes 130 can generate a packet that includes an IP header with a source and destination IP address, a source and destination port, a protocol, or some other information. When the packet is received by gateway 120, gateway 120 can first determine that the packet is to be communicated to gateway 121. Once the packet is determined to be forwarded to gateway 121, gateway 120 can hash addressing information or tuple information (IP addressing, ports, and protocol) from the packet to select a queue of processing queue 150-152. A hash is any function that can be used to map data, such as the addressing information, to fixed-sized values. In some examples, the hash may directly map the addressing information to a queue identifier. For example, a hash can be applied to the tuple that corresponds to values from zero to two. A zero would correspond to processing queue 150, a one would correspond to processing queue 151, and a two would correspond to processing queue 152. In other examples, a hash can be applied to identify a first value. Once the first value is determined, gateway 120 applies a remainder operation or modulo operation to the first value to select a queue identifier for the packet.

After the queue identifier is determined, gateway 120 can encapsulate the packet from the computing node and add the queue identifier value as a subset of bits in a sequence number portion of the encapsulated packet. The sequence number is used as an incrementing integer that is used to match up requests and responses, and to identify retransmissions of messages. The sequence number includes a defined number of bits (currently 32). Here, the upper most bits are allocated to define the queue identifier that corresponds to one of queues 150-152. Thus, a first portion of the sequence number bits are used to define the sequence number and the remaining portion of the sequence number bits are used to provide the sequence number. After the packet is encapsulated as an IPsec packet and the queue identifier is added to the packet, the encapsulated packet is communicated to gateway 121.

Gateway 121 receives the IPsec packet and checks the subset of bits in the sequence number to select a queue from queues 150-152. Once selected, the packet is placed in the corresponding processing queue and processed by gateway 121. The processing can include decapsulating the packet, applying firewall policies, applying routing policies, forwarding operations, or some other operations.

FIG. 2 illustrates an operation 200 of a gateway to identify and add bits in a sequence number portion to indicate a processing queue for a packet according to an implementation. The steps of operation 200 are referenced parenthetically in the paragraphs that follow to systems and elements of computing environment 100. Although demonstrated using a packet being communicated from gateway 120 to gateway 121, similar operations could be performed for a communication from gateway 121 to gateway 120.

In performing operation 200, gateway 120 identifies (201) a quantity of processing queues at a second gateway. The quantity of processing queues can be identified based on an exchange of information between the gateways, can be manually configured or defined for different destination gateways, or be provided to gateway 120 in some other manner. Operation 200 further receives (202) a packet from a computing node and identifies addressing attributes in the received packet.

As an illustrative example, a first computing node in computing nodes 130 can generate a packet that is received by gateway 120. Gateway 120 can identify addressing attributes in the IP header of the packet and determine that the packet is to be directed to gateway 121. In response to determining that the destination IP address requires that packet to be communicated via the IPsec tunnel between gateway 120-121, operation 200 determines (203) a queue identifier for the packet based on the addressing attributes in the packet and the quantity of processing queues. Once identified, operation 200 sets a subset of bits in a sequence number for a second packet that encapsulates the packet to the queue identifier.

In some implementations, to determine the queue identifier, gateway 120 will hash the addressing information (tuple information) from the packet received from the computing node to identify a first value. Once the first value is determined, gateway 120 will apply a remainder operation that identifies a queue identifier from the first value. As an example, a hash applied to the tuple information can determine a first value. The first value can then be divided by three corresponding to the quantity of processing queues 150-152 to generate a remainder value (i.e., zero, one, or two). The remainder value maps to a processing queue of processing queues 150-152. In other examples, the remainder operation may not be required when the hash value can be mapped directly to the available processing queues.

After the queue identifier is determined, the second packet is generated that encapsulates the packet as an IPsec tunnel packet. The IPsec tunnel packet includes bits that correspond to a sequence number, wherein the sequence number is part of an incrementing integer that is used to match up requests and responses, and to identify retransmissions of messages. The sequence number is part of the Encapsulating Security Payload (ESP) header for the second packet. Here, a first portion of the bits in the sequence number are allocated to define the queue identifier, while a second portion of the sequence number bits can be used to provide the sequence number. Referring to an example from computing environment 100, gateway 120 can perform a hash on tuple information for a first packet to identify a value between zero and two that corresponds to a queue in processing queues 150-152. The value can then be inserted in the two most upper bits of the sequence number of a second packet that encapsulates the first packet. After the queue identifier value is added to the sequence number, operation 200 communicates (204) the second packet with the queue identifier in the sequence number to the second gateway.

FIG. 3 illustrates an operation 300 of a gateway to assign a packet to a processing queue based on the bits in a sequence number portion according to an implementation. The steps of operation 300 are referenced parenthetically in the paragraphs that follow with reference to systems and elements of computing environment 100 of FIG. 1. Although demonstrated with a packet being received at gateway 121, similar operations can be performed by gateway 120 for received packets.

In operation 300, gateway 121 receives (301) a packet from a first gateway, wherein the packet comprises an IPsec packet received over a tunnel with the first gateway. In response to receiving the packet, gateway 121 performs packet inspection to identify (302) a queue identifier in the sequence number portion of the packet. In some examples, the packet inspection can identify a subset of bits in the sequence number portion of the packet (e.g., two uppermost bits). The value of the bits can then correspond to a queue of processing queues 150-152. For example, a zero value in the bits could correspond to processing queue 150, a one value in the bits could correspond to processing queue 151, and a two value in the bits could correspond to processing queue 152. Gateway 121 can include a data structure that maps the different bit values to a processing queue of processing queues 150-152. Once the queue identifier is identified in the sequence number, operation 300 assigns (303) the packet to a queue associated with the queue identifier. The processing queue can correspond to a core of a CPU, a processor, or some other division of queues for processing packets. Once assigned, the packet can be processed from the queue, wherein the processing can include decapsulating the packet, applying a firewall configuration, routing the decapsulated packet to a computing node of computing nodes 131, or performing some other action.

In some examples, in establishing the connection with gateway 120 at data center 110, gateway 121 may provide an indication of the ability to perform receive side scaling (RSS), wherein RSS is a network driver technology that enables gateway 121 to distribute received traffic across multiple queues (cores, processors, etc.). In some examples, the indication can further provide a quantity of available queues at gateway 121. The quantity can be used by gateway 120 to select the number of bits required in the sequence number portion of packets to indicate the queue identifier. Thus, when gateway 121 indicates that three processing queues are available, gateway 120 can designate two bits to indicate the queue identifier. However, when a gateway possesses additional or fewer processing queues, the number of bits used for the queue identifier can be adjusted by the sending gateway.

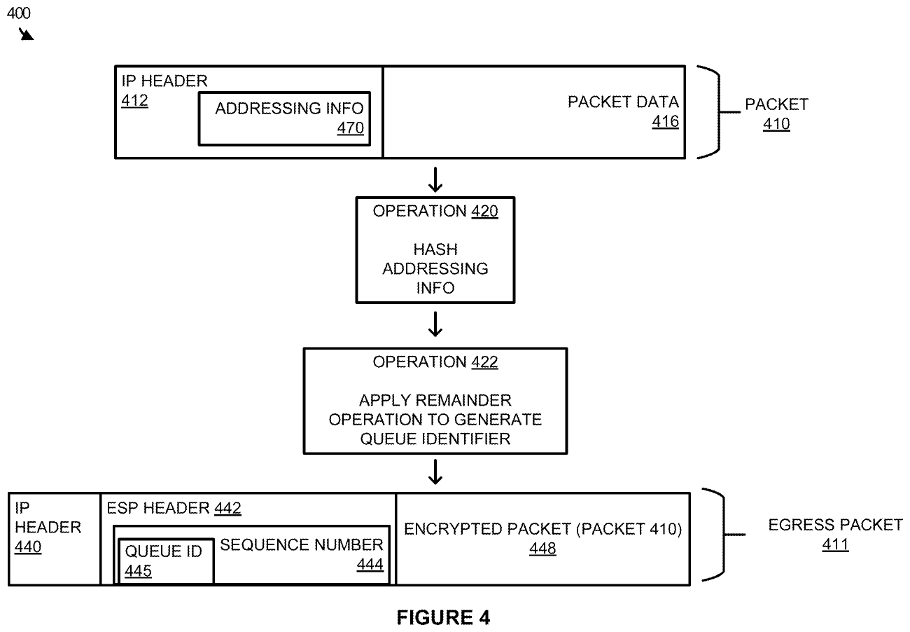

FIG. 4 illustrates an operational scenario 400 of generating an internet protocol security (IPsec) packet according to an implementation. Operational scenario 400 includes packet 410 and egress packet 411. Packet 410 includes IP header 412, addressing information 470, and packet data 416. Egress packet 411 includes encrypted packet 448 (representative of an encrypted version of packet 410), IP header 440, ESP header 442, sequence number 444, and queue identifier 445. Operational scenario 400 further includes operations 420 and 422 that are representative of operations performed by a gateway to send encapsulated packets to a second gateway. Operations 420 and 422 could be implemented by gateway 120 of FIG. 1 or some other gateway.

In operational scenario 400, packet 410 is generated by a computing node that is communicated to a first gateway. The computing node may comprise a physical computer or a virtualization instance (virtual machine, container, and the like). When the packet is received at the first gateway, the first gateway determines whether the packet is to be communicated over an IPsec tunnel to a second gateway, which can be determined via routing tables at the first gateway. When packet 410 is determined to be communicated to a second gateway via the IPsec tunnel, the first gateway performs operation 420 that hashes addressing information 470 found in packet 410. The addressing information is representative of tuple information for packet 410 and can include source and destination IP addressing, source and destination ports, and protocol information. Hashing addressing information 470 generates a first value of a defined size. For example, operation 420 can generate a 128-bit value from addressing information 470. Once the hash is performed on addressing information 470, the first gateway uses operation 422 to apply a remainder operation to the first value to generate the queue identifier. The remainder operation will divide the first value generated via hashing by the number of queues available at the second gateway. The remainder of this division will be a second value that will be used as the queue identifier. For example, the hash can generate a first value of 128 bits, but the second gateway can communicate an indication to the first gateway that four processing queues are available. Consequently, the first gateway can divide the first value by four to identify a remainder, a value between zero and three. The remainder value is then identified as the queue identifier for the packet.

Once the queue identifier is determined, the first gateway generates egress packet 411 that is representative of an IPsec packet that can securely communicate data to the second gateway. Egress packet 411 comprises encrypted packet 448, representative of an encrypted version of packet 410, IP header 440 that includes public addressing associated with the first gateway, and ESP header 442 that includes at least sequence number 444. Here, sequence number 444 is separated into two portions. A first portion that is used for queue identifier 445 generated using operations 420 and 422, and a second portion that is used for the sequence number itself. After egress packet 411 is generated, the packet can be communicated to the second gateway.

As described previously, in some examples, the second gateway can communicate an indication of the quantity of processing queues to the first gateway. The first gateway can then use this number to determine the number of bits that should be used for the queue identifier in the sequence number and/or the divisor used in association with the remainder operation. In an alternative example, the first gateway can be configured with an indication of the processing queues at the second gateway. For example, an administrator associated with the private network can indicate the number of processing queues at the second gateway by configuring the first gateway.

Although demonstrated in the previous example as applying both a hash and a remainder operation to determine the queue identifier, the first gateway or sending gateway may only apply a hash in some examples. The hash can generate a value of a length required by the second gateway to indicate the processing queue. For example, the second gateway may include four different processing queues. Accordingly, the hash of the addressing information can indicate values from zero to three using two different bits to indicate the queue for the packet.

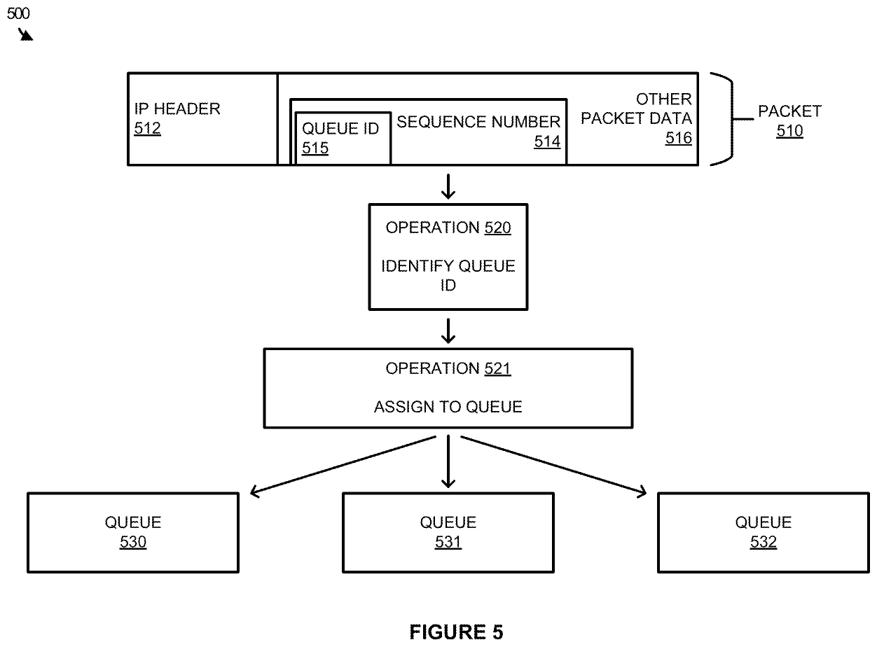

FIG. 5 illustrates an operational scenario 500 of assigning a received packet to a processing queue according to an implementation. Operational scenario 500 includes packet 510 with IP header 512 and other packet data 516, wherein other packet data 516 includes sequence number 514 and queue identifier 515. Operational scenario 500 further includes operations 520-521 and processing queues 530-532.

In operational scenario 500, packet 510 is received at a gateway from a second gateway, wherein packet 510 can represent an IPsec packet received over a tunnel from the second gateway. In response to receiving the packet, the gateway applies operation 520 to identify queue identifier 515 in the packet. This operation can be performed using packet inspection to identify relevant bits associated with the queue identifier. Once the queue identifier is obtained, the gateway further performs operation 521 to assign a processing queue for the packet from processing queues 530-532. In at least one example, the gateway can maintain a data structure that maps values in the queue identifier portion of a packet to a corresponding queue. Thus, using the example in operational scenario 500, a first value (e.g., zero) can be mapped to processing queue 530, a second value can be mapped to processing queue 531, and a third value can be mapped to processing queue 532. The processing queues can correspond to different cores of a CPU, different CPUs, or some other division of processing resources.

In some implementations, the receiving gateway can exchange information with the sending gateway to configure the parameters associated with the tunnel. The receiving gateway can indicate the ability to perform RSS, the quantity of processing queues at the receiving gateway, hardware information associated with the receiving gateway (e.g., manufacturer), or some other configuration information associated with the receiving gateway. The sending gateway can use the information to select the number of bits that are used to define the queue identifier in the sequence number of packets over the tunnel. In other implementations, rather than exchanging the configuration information between the gateways, an administrator of the computing network can configure each of the gateways to indicate the quantity of queues at the destination gateway. The configuration can be used to manually indicate the number of bits required by the queue identifier.

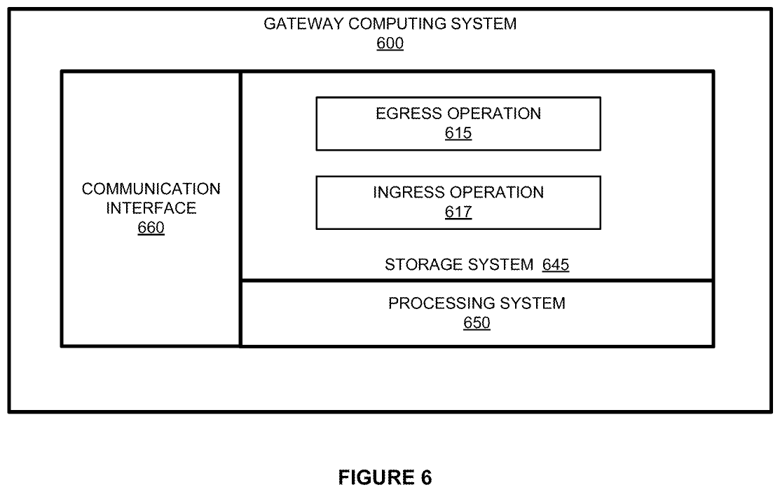

FIG. 6 illustrates a gateway computing system 600 to communicate IPsec packet that indicate a processing queue for the packet using the sequence number portion according to an implementation. Computing system 600 is representative of any computing system or systems with which the various operational architectures, processes, scenarios, and sequences disclosed herein for a gateway can be implemented. Computing system 600 is an example of gateways 120-121 of FIG. 1, although other examples may exist. Computing system 600 includes storage system 645, processing system 650, and communication interface 660. Processing system 650 is operatively linked to communication interface 660 and storage system 645. Computing system 600 may further include other components such as a battery and enclosure that are not shown for clarity.

Communication interface 660 comprises components that communicate over communication links, such as network cards, ports, radio frequency (RF), processing circuitry and software, or some other communication devices. Communication interface 660 may be configured to communicate over metallic, wireless, or optical links. Communication interface 660 may be configured to use Time Division Multiplex (TDM), Internet Protocol (IP), Ethernet, optical networking, wireless protocols, communication signaling, or some other communication format—including combinations thereof. Communication interface 660 may be configured to communicate with other gateways and may further communicate with one or more computing nodes, such as host computing systems, desktop computing systems, or some other computing system.

Processing system 650 comprises microprocessor and other circuitry that retrieves and executes operating software from storage system 645. Storage system 645 may include volatile and nonvolatile, removable, and non-removable media implemented in any method or technology for storage of information, such as computer readable instructions, data structures, program modules, or other data. Storage system 645 may be implemented as a single storage device but may also be implemented across multiple storage devices or sub-systems. Storage system 645 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no case is the storage media a propagated signal.

Processing system 650 is typically mounted on a circuit board that may also hold the storage system. The operating software of storage systems 645 comprises computer programs, firmware, or some other form of machine-readable program instructions. The operating software of storage system 645 comprises egress operation 615 and ingress operation 617. The operating software on storage system 645 may further include utilities, drivers, network interfaces, applications, or some other type of software. When read and executed by processing system 650 the operating software on storage system 645 directs computing system 600 to operate as described herein. In some implementations, the software may provide operations 200 and 300 described in FIGS. 2 and 3.

In at least one implementation, egress operation 615 directs processing system 650 to obtain a packet from a computing node, wherein the packet comprises an IP packet with first addressing information or tuple information. The packet can be received from a virtualized instance or can be received from a physical computer. Once received, egress operation 615 determines whether the packet is destined for a gateway accessible via an IPsec tunnel based on routing policies maintained by computing system 600. When the destination of the IP packet is required to be sent via IPsec tunnel to a second gateway, the tuple information in the header of the packet is processed to determine a queue identifier (i.e., value) for the packet, wherein the queue identifier is used to select a queue from a plurality of queues at the destination gateway. In some examples, the value that results from the hash can be used directly to identify a queue at the second gateway. For example, a hash may convert the attributes in the tuple to a two-bit value (i.e., capable of being 0-3). When the second gateway includes four processing queues, no other action is required, and the value generated from the hash can be used for the queue identifier. In another example, the hash can create a first value and a remainder operation can divide the first value by the number of available processing queues at the second gateway to generate a second value. The second value is then used as the queue identifier.

After the queue identifier is determined using at least the hash operation, egress operation 615 directs processing system 650 to generate an IPsec packet that encapsulates the packet and includes the queue identifier in the sequence number portion of the ESP header. Here, the sequence number is divided into two portions. A first portion of bits that is used to define the queue identifier and a second portion of bits that is used to define the sequence number. In some examples, the queue identifier uses the uppermost bits, however, the queue identifier could be placed in the lower bits as well.

In some implementations, egress operation 615 will select the number of bits to use for the queue identifier based on information provided from the receiving gateway or the second gateway for the tunnel. The receiving gateway can indicate that it has RSS capability, can indicate the number of available processing queues, can indicate a device identifier (e.g., device name), or some other information. From the information, egress operation 615 can determine the number of bits required to distribute packets to the different processing queues. For example, when the second gateway indicates that four processing queues are available, egress operation 615 can use two bits in the sequence number portion of the packet to identify the processing queue.

In other implementations, rather than exchanging information with the second gateway, gateway computing system 600 can be configured by an administrator with information required to determine the bit-length for the receiving gateway. The administrator can provide the number of processing queues, hardware information for the receiving gateway, or some other information to select the number of bits in the sequence number portion of a packet for the queue identifier.

In addition to communicating packets to a second gateway, gateway computing system 600 includes ingress operation 617 that directs processing system 650 to receive a packet at communication interface 660. In response to receiving the packet, ingress operation 617 directs processing system 650 to perform packet inspection and identify bits in the sequence number portion of the packet to identify a processing queue for the packet from a plurality of processing queues on computing system 600. The processing queues can comprise cores of a CPU, different CPUs, or some other division of resources. For example, computing system 600 may include four different processing queues capable of processing ingress packets from other gateways. In response to receiving the packet, ingress operation 617 can identify a value in two bits of the sequence number portion of the packet to identify a processing queue from the packet. The two bits can be used to define an integer from zero to three that corresponds to different processing queues. Thus, when packet includes a value of zero in the bits, the packet can be assigned to a first processing queue, whereas when the packet includes a value of one, the packet can be assigned to a different processing queue. Once ingress operation 617 assigns the packet to a processing queue, the processing queue can process the packet in accordance with a first-in first-out process. The processing of the packet can include decapsulating the packet to identify a second packet, applying a firewall configuration to the decapsulated packet, applying routing rules, or some other operation in association with the packet.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method comprising:
in a first gateway, receiving a packet from a second gateway;
in the first gateway, identifying a value of a subset of bits in a sequence number portion of the packet;
in the first gateway, selecting a queue from a plurality of queues at the first gateway to process the packet based on the value of the subset of bits.

2. The method of claim 1, wherein the packet comprises an internet protocol security (IPsec) packet.

3. The method of claim 1 further comprising:
in the second gateway, determining a hash value based at least on a hash of tuple information from a second packet encapsulated in the packet;
in the second gateway, setting the subset of bits of the sequence number portion of the packet to the hash value; and
in the second gateway, communicating the packet to the first gateway.

4. The method of claim 3, wherein the tuple information comprises a source IP address, a destination IP address, a source port, and a destination port.

5. The method of claim 4, wherein the tuple information further comprises a protocol.

6. The method of claim 1 further comprising:
exchanging, between the first and second gateway, an indication of receive side scaling functionality.

7. The method of claim 6, wherein the indication further indicates a quantity of queues at the first gateway.

8. The method of claim 7 further comprising:
in the second gateway, determining the value of the subset of bits based at least on a hash of tuple information from a second packet encapsulated in the packet and the quantity of queues at the first gateway;
in the second gateway, setting the subset of bits of the sequence number portion of the packet to the value; and
in the second gateway, communicating the packet to the first gateway.

9. The method of claim 1 further comprising:
in the first gateway, receiving a second packet from the second gateway;
in the first gateway, identifying a second value of a second subset of bits in a sequence number portion of the second packet; and
in the first gateway, selecting a second queue from the plurality of queues on the first gateway based on the second value of the second subset of bits.

10. A system comprising:
a first gateway; and
a second gateway configured to:
receive a packet from the first gateway;
identify a value of a subset of bits in a sequence number portion of the packet;
select a queue from a plurality of queues at the first gateway to process the packet based on the value of the subset of bits.

11. The system of claim 10, wherein the packet comprises an internet protocol security (IPsec) packet.

12. The system of claim 10, wherein the first gateway is further configured to:
determine a hash value based at least on a hash of tuple information from a second packet encapsulated in the packet;
set the subset of bits of the sequence number portion of the packet to the hash value; and
communicate the packet to the second gateway.

13. The system of claim 12, wherein the tuple information comprises a source IP address, a destination IP address, a source port, and a destination port.

14. The system of claim 13, wherein the tuple information further comprises a protocol.

15. The system of claim 10, wherein the second gateway is further configured to:
communicate an indication of receive side scaling functionality to the first gateway.

16. The system of claim 15, wherein the indication further indicates a quantity of queues at the second gateway.

17. The system of claim 16, wherein the second gateway is further configured to:
determine the value of the subset of bits based at least on a hash of tuple information from a second packet encapsulated in the packet and the quantity of queues at the first gateway;
set the subset of bits of the sequence number portion of the packet to the value; and
communicate the packet to the first gateway.

18. A computing apparatus comprising:
a storage system;
a processing system operatively coupled to the storage system; and
program instructions stored on the storage system to operate a gateway that, when executed by the processing system, direct the computing apparatus to:
receive a packet from a computing node;
hash tuple information from the packet to generate a value corresponding to a queue identifier;
add the value as a subset of bits in a sequence number portion of a second packet that encapsulates the packet; and
communicate the second packet to a second gateway.

19. The computing apparatus of claim 18, wherein the tuple information comprises a source IP address, a destination IP address, a source port, a destination port, and a protocol.

20. The computing apparatus of claim 18, wherein the program instructions further direct the computing apparatus to receive an indication of a quantity of queues available at the second gateway, and wherein the value comprise an integer value less than the quantity of queues.
